(19) United States
(12) Patent Application Publication
(10) Pub. No.: US 2025/0015551 A1
(43) Pub. Date: Jan. 9, 2025

(54) HYBRID-PUMPED FIBER AMPLIFIER

(71) Applicant: BAE Systems Information and Electronic Systems Integration Inc., Nashua, NH (US)

(72) Inventors: Spencer L. Horton, Nashua, NH (US); Ezra S. Allee, Windham, NH (US)

(73) Assignee: BAE Systems Information and Electronic Systems Integration Inc., Nashua, NH (US)

(21) Appl. No.: 18/709,678

(22) PCT Filed: Nov. 19, 2021
(86) PCT No.: PCT/US2021/060129

§ 371 Date: May 13, 2024

(51) Int. Cl. H01S 3/067; H01S 3/094; H01S 3/0941; H01S 3/16; H01S 3/23

(52) U.S. Cl. CPC H01S 3/06754; H01S 3/094007; H01S 3/094011; H01S 3/094042; H01S 3/09415; H01S 3/1616; H01S 3/2375

(57) ABSTRACT

Techniques to passively suppress or otherwise reduce stimulated Brillouin scattering (SBS) in a pumped fiber laser system. The system can be co-pumped with a tandem pumping technique, and counter-pumped with the direct diode pumping method. In an example, a pumped fiber laser system includes a fiber, a tandem pump, and a direct diode pump. The fiber has a core, an inner cladding around the core, and an outer cladding around the inner cladding. The tandem pump co-pumps light of a first wavelength in the inner cladding from a first end of the fiber, and the direct diode pump counter-pumps light of a second wavelength in the outer cladding from a second end of the fiber. A longitudinal temperature gradient can form along the fiber laser in response to this hybrid-pumping, which can combine both tandem and direct diode pumping.

### BACKGROUND

A limiting factor of high power fiber lasers (e.g., 2 μm fiber lasers) is stimulated Brillouin scattering (SBS). When SBS gain is above a threshold, SBS can cause light to be back-reflected into the laser, potentially damaging or destroying sensitive components within the laser. The SBS threshold, or the level of SBS gain beyond which failure can occur, is driven by the generated signal in the gain fiber and the SBS gain profile.

### SUMMARY

In an example, a pumped fiber laser system is provided, which includes a fiber laser, a tandem pump configured to co-pump light of a first wavelength to a first end of the fiber amplifier inside an inner-cladding, and a direct diode pump configured to counter-pump light of a second wavelength to a second end of the fiber amplifier through an outer cladding. The tandem pump and the direct diode pump, in operation, collectively produce a temperature gradient between the first end and the second end. In some cases, the temperature gradient between the first end and the second end can depend on: core fiber size of the fiber amplifier; an inner cladding size of the fiber amplifier; an outer cladding size of the fiber amplifier; the first wavelength; the second wavelength; or a ratio of co-pumping to counter-pumping. In some cases, the temperature gradient has a quasi-linear profile along a length between the first and second ends of the fiber laser and can be configured to suppress or otherwise reduce stimulated Brillouin scattering (SBS). The total fiber laser system can have a power, for instance, greater than 1 kilowatt. In some examples, the first wavelength is between 1900 nanometers and 2000 nanometers, the second wavelength is between 790 nanometers and 800 nanometers, and the output wavelength of the fiber laser is between 1.9 microns and 2.1 microns. In some cases, the fiber laser comprises a doped fiber amplifier laser (e.g., a thulium doped fiber amplifier laser). In some such cases, an amplifier fiber of the doped fiber amplifier laser comprises a triple-clad fiber. In some such cases, the tandem pump is configured to co-pump the light of the first wavelength in an inner cladding of the triple-clad fiber, and the direct diode pump is configured to counter-pump the light of the second wavelength in an outer cladding of the triple-clad fiber.

In another example, a pumped fiber laser system is provided, which includes a fiber, a tandem pump, and a direct diode pump. The fiber has a core, an inner cladding around the core, and an outer cladding around the inner cladding. The tandem pump is configured to co-pump light of a first wavelength in the inner cladding of the fiber and from a first end of the fiber. The direct diode pump is configured to counter-pump light of a second wavelength in the outer cladding of the fiber and from a second end of the fiber.

In another example, a method of pumping a fiber laser is provided, which includes co-pumping light of a first wavelength to a first end of the fiber laser using a tandem pumping technique and counter-pumping light of a second wavelength to a second end of the fiber laser. A temperature gradient can form between the first end and the second end in response to the co-pumping and the counter-pumping.

### BRIEF DESCRIPTION OF THE DRAWINGS

FIG. 1 is a block diagram illustrating the architecture of a hybrid-pumped fiber amplifier, in accordance with an example of the present disclosure.

FIG. 2 schematically illustrates further details of a hybrid-pumped fiber amplifier, in accordance with an example of the present disclosure.

FIG. 3 graphically illustrates a calculated stimulated Brillouin scattering (SBS) threshold increase versus a maximum temperature gradient for different thermal temperature profiles.

FIG. 4 is a cross-sectional view illustrating fiber claddings of a hybrid-pumped fiber amplifier, in accordance with an example of the present disclosure.

FIG. 5 illustrates a calculated core and polymer-glass interface temperature profile along the length of a hybrid-pumped fiber amplifier, in accordance with an example of the present disclosure.

FIG. 6 illustrates calculated effective SBS gain spectra for different temperature profiles of a hybrid-pumped fiber amplifier, in accordance with an example of the present disclosure.

FIG. 7 is a flow diagram illustrating a method of dual end pumping a fiber laser, in accordance with an example of the present disclosure.

### DETAILED DESCRIPTION

Techniques are disclosed to passively suppress or otherwise reduce stimulated Brillouin scattering (SBS) in a high average power fiber amplifier. In an example, the techniques are implemented as a hybrid-pumped fiber amplifier. In more detail, the system can be co-pumped with a tandem pumping technique, and counter-pumped with the direct diode pumping method, hence the system is hybrid-pumped. In one such example, a pumped fiber amplifier system includes a fiber, a tandem pump, and a direct diode pump. The fiber has a core, an inner cladding around the core, and an outer cladding around the inner cladding. The tandem pump co-pumps light of a first wavelength in the inner cladding from a first end of the fiber, and the direct diode pump counter-pumps light of a second wavelength in the outer cladding from a second end of the fiber. A longitudinal temperature gradient can form along the fiber laser in response to this hybrid-pumping. Numerous examples and configurations will be apparent in light of this disclosure.

### General Overview

As previously explained, a limiting factor of high power fiber lasers is the non-linear effect of stimulated Brillouin scattering (SBS). Various approaches have been used to suppress or otherwise reduce SBS in fiber lasers. One such approach is to seed the fiber with laser radiation having a spectral width that is greater than the Brillouin linewidth. Such an approach can be implemented, for example, using a multimode laser as a broad bandwidth seed laser. Another approach is to broaden the laser linewidth for SBS suppression by externally modulating the laser radiation. To this end, current narrow linewidth high power laser systems use active techniques to mitigate this effect, such as techniques that use an external feedback mechanism. Such techniques may not be desirable in certain applications.

Thus, and according to some embodiments, techniques and systems are provided herein that can passively suppress or otherwise reduce SBS, without the need for feedback. As will be explained in turn, the techniques enable tailoring of a generated laser signal (e.g., 2 μm signal) and the SBS signal gain separately. The system thereby minimizes or otherwise reduces SBS and achieves, for example, a 2 μm fiber laser with greater than 1 kW output power. In some embodiments, a laser system, which may also be referred to as hybrid-pumped 2 μm fiber laser, can be co-pumped with a tandem pumping technique, and counter-pumped with the direct diode pumping method. A longitudinal temperature gradient can form along the fiber laser in response to this hybrid-pumping. This gradient, in turn, can optimally suppress or otherwise reduce SBS, enabling higher power operation than standard fiber lasers.

### Architecture

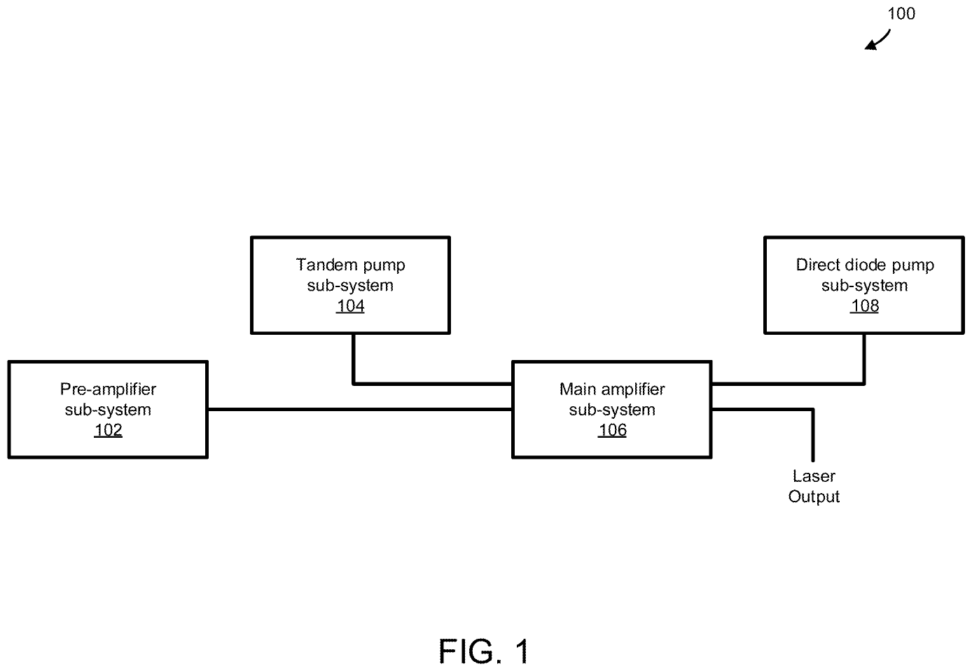

FIG. 1 is a block diagram illustrating the architecture of a hybrid-pumped fiber amplifier 100, in accordance with an example of the present disclosure. In this example, hybrid-pumped fiber amplifier 100 includes a pre-amplification sub-system 102, a tandem pumping sub-system 104, a main amplification sub-system 106, and a direct diode pumping sub-system 108.

During operation of hybrid-pumped fiber amplifier 100, and according to some example embodiments, an input signal sufficient to extract more than a kilowatt of amplification is needed. The input signal may first pass through pre-amplification sub-system 102. The signal then passes through main amplification sub-system 106, which may include a thulium doped fiber amplifier (TDFA), in some cases. Main amplification sub-system 106 can be hybrid-pumped, for example, co-pumped by tandem pumping sub-system 104 from one end, and counter-pumped by direct diode pumping sub-system 108 from the other end. Tandem pumping sub-system 104 can include, for example, a tandem pump (for example, containing four thulium doped fiber lasers), a fused fiber pump combiner, and a cladding light stripper to remove light from the fiber claddings. Direct diode pumping sub-system 108 may include, for example, a direct diode pump, a fused fiber pump combiner, and a cladding light stripper to remove light from the fiber claddings. Variations will be apparent in light of this disclosure. For instance, the cladding light strippers may be implemented independently of the pumping sub-systems, as may be the pump combiners. Likewise, an optical isolator may be implemented independently of the input signal for amplification. To this end, the various groupings of components that make up a given sub-system of examples provided herein are not intended to limit the present disclosure to that particular arrangement; rather, components may be configured in one or more groupings and/or individually and still collectively operate to bring about benefits as described herein.

In some embodiments of the present description, the balance between maintaining a low heat load and producing a large longitudinal temperature gradient between the two ends of main amplification sub-system 106 is addressed by hybrid dual end pumping. In particular, the profile of the resulting temperature gradient can be tailored by design elements of the architecture of laser system 100, for example the temperature gradient can be tailored to have a quasi-linear profile. Such a temperature gradient can passively provide relatively strong suppression or reduction of SBS, as described herein below. As a result, in main amplification sub-system 106, the output signal can be amplified to a relatively high-power laser signal, above 1 kW, while maintaining a narrow linewidth.

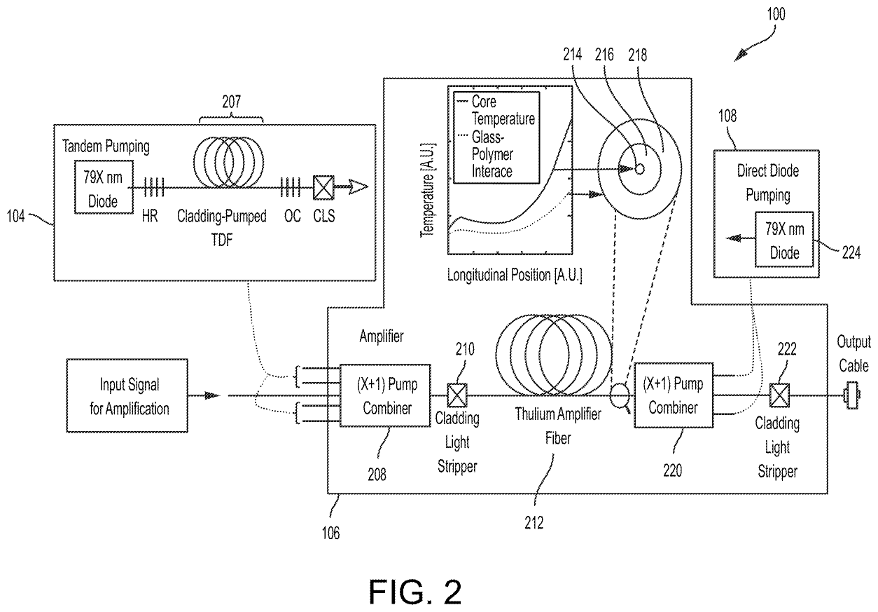

FIG. 2 schematically illustrates further details of the architecture of hybrid-pumped fiber amplifier 100, in accordance with an example of the present disclosure. As shown, the system architecture includes a narrow linewidth input signal of sufficient power for amplification of powers above 1 kW. The input signal is coupled into the main amplification sub-system 106, which is co-pumped by tandem pumping sub-system 104, which may contain multiple 19XX nm pump lasers 207.

In particular, in some embodiments, the sub-system 104 can be co-pumped via inner cladding 216 of thulium amplifier fiber 212 using light of a first wavelength (for example, 1900 nm, or in the 1900 nm to 2000 nm region) using a tandem pumping technique (also referred to as resonant pumping), a technique that is capable of power scaling a TDFA to over 6 kW. Tandem pumping is further described in U.S. Pat. No. 9,627,838, which is incorporated herein by reference in its entirety. In tandem pumping, a TDFA is pumped in-band to the 3F4 lasing level by a 1900 nm thulium doped fiber laser (TDFL). The relatively high quantum efficiency of this technique can reduce heating in the amplifierfiber 212, as it distributes waste heat from the pump diode evenly over the TDFLs.

As can be further seen in FIG. 2, tandem pumping sub-system 104 can feed into a pump combiner 208 (for example, an (X+1) pump combiner, where X may represent a number of inputs to pump combiner 208, such as tandem pump lasers 207). In pump combiner 208, the signals of the tandem pump lasers 207 are combined and coupled into the inner cladding of the amplifier fiber 212. The signal power can then be boosted from, for example, approximately 50-60 dB of gain in the amplifier fiber 212. In some examples, the final output power is greater than 1 kW. In this example, amplifier fiber 212 can be a hybrid-pumped triple-clad TDF, with a TDF core 214, an inner cladding 216, and an outer cladding 218. The generated output signal, which in some cases is a 2 m signal, can travel in the core 214 of triple clad fiber 212, while the tandem co-pump signal can travel in inner cladding 216, and the direct diode counter-pump signal can travel in outer cladding 218.

In some embodiments, the system can be counter-pumped using light of a second wavelength (for example, between 790 nm and 800 nm) using a direct diode pumping technique via the outer cladding 218. In the example of FIG. 2, a side coupled pump combiner 220 (for example, an (X+1) side coupled pump combiner, where X may represent a number of inputs to side coupled pump combiner 220, such as diodes 224) is used to counter-pump directly with 79X nm diodes 224 of direct diode pumping sub-system 108. This pumping scheme enables light strippers to be used in the claddings to strip out light from the direct diode pump 108 and tandem pump 104 separately without depositing heat into the pump combiners. In particular, cladding light stripper 210 strips light from outer cladding 218, and cladding light stripper 222 strips light from inner cladding 216.

While direct diode pumping offers the advantage of being a less complex approach relative to counter-pumping, it produces a significant heat load. To this end, the outer coating temperature of amplifier fiber 212 can be managed to maintain, for instance, coating (e.g., polymer) stability and fiber reliability. The radial heat profile produced by direct diode counter-pumping, and the temperature at the cladding-coating interface, is largely a function of the diameter of outer cladding 218 and of the dopant concentration of amplifier fiber 212. In some examples having a polymer outer coating, the diameter of outer cladding 218 can be chosen to maintain the polymer coating temperature below 90° C., while providing sufficient temperature gradient for SBS suppression or reduction, and supporting fiber splicing.

Because the tandem co-pumping technique has a relatively high quantum efficiency, the steady-state temperature at the first end of amplifier fiber 212 can be relatively low. By contrast, the direct diode counter-pumping produces a large amount of heat, engendering a higher steady-state temperature at the second end of amplifier fiber 212. As a result, and according to an embodiment of the present disclosure, the longitudinal temperature gradient across amplifier fiber 212 can be considerably larger than in other TDFA systems, for example direct diode pumping.

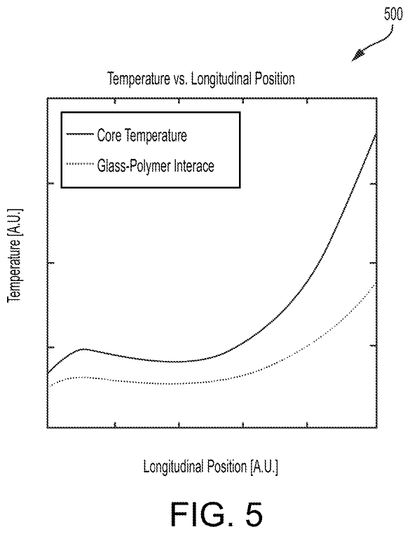

Moreover, according to some such embodiments, it is possible to tailor the temperature gradient and 2 μm signal profile longitudinally along amplifier fiber 212 to optimally suppress SBS, or otherwise meet a given SBS specification. In particular, the architecture 200 of the TDFA can be tailored to produce a quasi-linear temperature profile along the fiber and maximize the SBS suppression, or otherwise meet a given SBS specification. Direct diode pumping can be used to drive the gradient across the fiber, while remaining safely below the maximum temperature of the polymer coating, according to some examples. Tandem pumps may provide the additional pump-power needed to effectively reach the desired output output laser power. Note that heating of the tandem and direct diode pumps can be tailored separately. For instance, the design parameters that can affect the temperature profile include: doping concentration, core size, inner cladding size, outer cladding size, the tandem pump wavelengths, the direct diode pump wavelengths, and tandem to direct diode pumping ratio. For example, the inner and outer cladding sizes and tandem and direct diode pump wavelengths provide independent design control over the tandem and direct diode heating. The minimum radius of inner cladding 216 is ultimately limited by the pump combiner geometry and pedestal numerical aperture (NA), while the outer cladding 218 can be large enough to maintain a polymer coating temperature below 90° C. A calculated heat profile for an example hybrid-pumped system according to an embodiment of the present disclosure will be presented in FIG. 5 below.

The output power for TDFLs pumped by direct diode pumping may be limited by the maximum temperature rating on the polymer coating the TDF, since standard TDF polymer coatings become unstable and limit fiber reliability if heated above 90° C. While tandem pumping is capable of power scaling to over 6 kW, power scaling in narrow linewidth TDFAs may be constrained by SBS limits significantly below 1 kW. By contrast, a target output power value above 1 kW at narrow linewidths may be achievable using a hybrid-pumping system according to an embodiment.

Passive SBS suppression in TDF may, according to one approach of the invention, be accomplished by co-pumping and counter-pumping the amplifier fiber with 79X nm diodes and creating a quasi-quadratic temperature gradient in the fiber. The only design parameters in the direct diode approach are the core size, cladding size, and diode wavelength. Thus, the temperature profile manipulation is limited with such an approach, and it does not enable any modification of the 2 m signal to further suppress SBS. Moreover, such an approach does not allow for cladding light strippers, so the fiber length may be set to maximally absorb the pump (which exacerbates SBS), and the residual pump power may be deposited in the pump combiners. By contrast, a hybrid-pumping system according to an embodiment can achieve improved SBS suppression, and hence greater laser output power and versatility, by producing a longitudinal temperature gradient along the TDFA's length, as described herein.

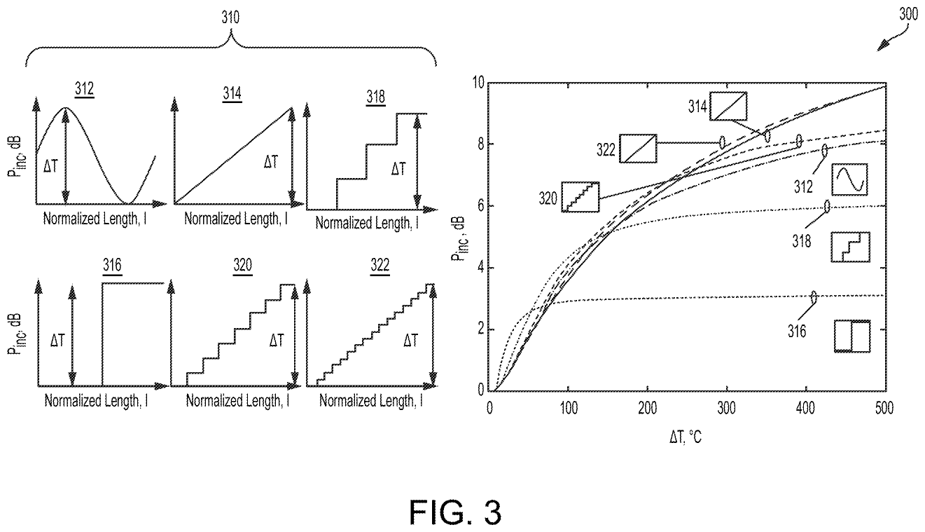

FIG. 3 illustrates a calculated SBS power threshold increase 300 for different thermal temperature profiles T(z) 310 versus a peak temperature gradient value, ΔT=max₂{T(z)}-min_{z}{T(z)}. Here, the SBS power threshold increase P_{inc} refers to a change in the SBS power threshold, in particular a change in the laser output power at which the onset of catastrophic SBS occurs. FIG. 3 is excerpted from “Increase of the SBS threshold in a short highly nonlinear fiber by applying a temperature distribution,” J. Lightwave Technol. 19.11 (2001): 1691, by J. Hansryd, et al. Note that calculated SBS power threshold increase 300 refers to a general thulium fiber system, not necessarily to a narrow linewidth system.

To calculate the results shown here, the effective SBS gain G(v) can first be calculated by integrating the gain profile along the fiber length: G(v)=∫₀^{L}P(z)G(v,T(z))dz, where P(z) is the 2 μm signal level at a position z along the fiber and G(v, T(z)) is the SBS gain spectrum at a frequency v, which may have a Lorentzian-shaped peak of height go and location v_{B}. In FIG. 3, the SBS power threshold increase P_{inc} is calculated from

$${P}_{inc} = - 10 log \frac{{G}_{max}}{{g}_{0}} = - 10 log \frac{1}{{g}_{0}} {\int }_{0}^{L} P ( z ) G ( {ν}_{max} , T ( z ) ) dz ,$$

where Gₘₐₓ=G(vₘₐₓ) is the maximum value of G(v).

As shown, a 10 dB increase in the SBS threshold can be achieved with the application of a linear temperature gradient of 500° C. To utilize this method of increasing the SBS threshold to its full potential, in some examples the temperature gradient can be made as large as possible along the fiber length, while maintaining a polymer temperature below 90° C.

It is also important to note the shape 310 of thermal gradient that can be used to suppress or otherwise reduce SBS. A position-dependent temperature profile can cause the SBS gain spectrum to spread along the fiber length, in particular to extend at a lower amplitude over a greater distance along the fiber, thereby increasing the SBS power threshold. In particular, in the equation G(v)=∫₀^{L}P(z)G(v,T(z))dz, the SBS gain spectrum G(v, T(z)) is a Lorentzian function with a temperature-dependent peak location, v_{B}(T)≠v_{B}(T₀)+k (T(z)−T₀), which also may be referred to as a Stokes shift. Here the proportionality constant k is related to the logarithmic derivative of the medium's acoustic velocity with respect to temperature at T=T₀. Therefore, in response to a temperature gradient, the effective SBS gain G(v) has a lower peak amplitude, spreading instead at lower amplitudes over a broader range of frequencies. Thus, according to some embodiments of the present disclosure, the effective gain at any given frequency v can be engineered to remain beneath the power threshold for the onset of catastrophic SBS.

Of the examples shown in FIG. 3, the best SBS threshold increase is achieved with a linear gradient. This can be understood because the linear temperature gradient maximizes the variation in peak locations v_{B}(T). This continuous shift of the peak in the SBS gain spectrum keeps the peak SBS gain value low, thereby increasing the SBS onset threshold.

Still, the examples of FIG. 3 show that to optimally suppress SBS, or otherwise meet a given SBS specification, involves a relatively large gradient across the length of the fiber. For example, a 10 dB increase in the SBS threshold results from a linear temperature gradient of 500° C., as shown in FIG. 3. The relatively large gradients and the limited maximum temperature of 90° C. in the polymer coating may make it difficult to apply an external gradient to the fiber that will have an appreciable effect on the SBS threshold. Instead, to achieve higher temperature gradients, in some examples it is possible to apply the heat inside the fiber directly.

Whereas tandem pumping offers a path to high power scaling, a narrow linewidth seed poses a challenge for either tandem or direct diode pumping. As illustrated in FIG. 3, a large, longitudinal temperature gradient may increase the SBS threshold significantly. However, a purely tandem pumped system would exhibit only a very small thermal gradient, therefore offering minimal SBS suppression. A solely direct diode pumped system, on the other hand, may use a dual-end-pumped geometry to keep the temperature of the polymer coating below its maximum temperature, which may result in a non-ideal quasi-parabolic longitudinal heat profile. By contrast, a hybrid-pumping system according to an embodiment of the present disclosure can achieve large quasi-linear longitudinal temperature gradients along the fiber laser, while limiting the temperature of the polymer coating, so as to suppress or otherwise reduce SBS significantly.

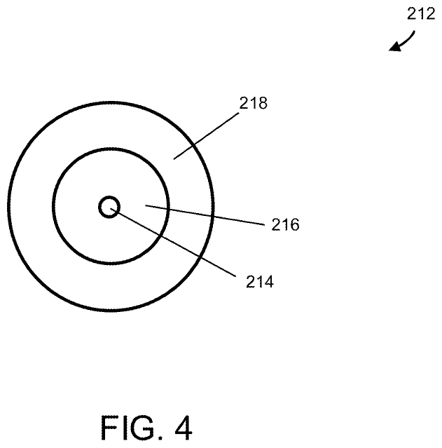

FIG. 4 is a cross-sectional view illustrating fiber claddings of a hybrid-pumped fiber amplifier fiber 212, in accordance with an example of the present disclosure. As described above, in some embodiments, the disclosed amplifier fiber 212 can be triple clad TDFA, with core 214, inner cladding 216, and outer cladding 218. In an embodiment, the tandem pump can be configured to co-pump light of a first wavelength in inner cladding 216 and from a first end of TDF 214. The direct diode pump can be configured to counter-pump light of a second wavelength in the outer cladding 218 and from a second end of the TDF 214.

Whereas pump diodes for wavelengths between approximately 790 nm and 800 nm (referred to herein as 79X nm) can generally use a low-index polymer coating, for example a standard polymer coating, on double-clad fibers as a waveguide, tandem pumping in the 1900 nm to 2000 nm wavelength range may use a triple-clad fiber, such as amplifier fiber 212 in the example of FIG. 4, because the polymer coating is absorptive of wavelengths in this range. Therefore, in some examples, the pedestal present in the amplifier fiber 212, which may be used to maintain low NA when the core is heavily doped with Al₂O₃, can also function as the inner cladding 216, thereby serving as a waveguide for tandem pump 104.

The heat profile produced by the direct diode counter-pumping may be largely a function of the diameter of outer cladding 218, which influences how heat is distributed, and the dopant concentration. As a result, doping concentration, the sizes of core 214, inner cladding 216, and outer cladding 218 are among the example design parameters that can be adjusted in order to tailor the longitudinal temperature gradient across amplifier fiber 212, according to an embodiment.

The minimum radius of inner cladding 216 is ultimately limited by the pump combiner geometry and pedestal numerical aperture (NA), while the outer cladding 218 can be large enough to maintain a polymer temperature below 90° C. One example method for end-pumping fiber amplifiers with high transmission efficiency of the pump input ports and signal fiber is an (N+1)×1 configured tapered fiber bundle.

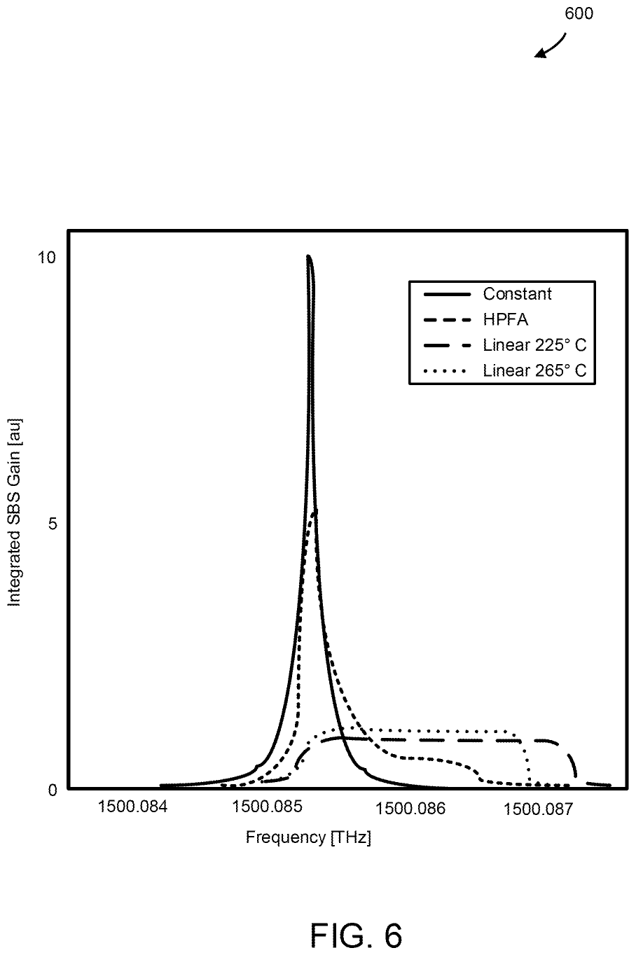

FIG. 5 illustrates a calculated core and polymer-glass interface temperature profile 500 along the entire length of a TDF of a hybrid-pumped fiber amplifier, in accordance with an example of the present disclosure. The solid curve shows the temperature in core 214, while the dotted curve shows the temperature at the glass polymer interface, such as at an outer surface of outer cladding 218. The results plotted in FIG. 5 are calculated using energetics models of TDFAs and TDFLs combined with a radially symmetric heat distribution model to calculate the temperature profile. These models can also be combined with SBS threshold calculations, as in the examples of FIGS. 3 and 6.

As shown in FIG. 5, a large temperature gradient, such as 160° C., can be driven along the TDF core, while also keeping the TDF's polymer coating at a safe operating temperature, such as below 90° C. Moreover, the results show that a hybrid-pumping system according to an embodiment can create large temperature gradients that optimally suppress SBS, or otherwise meet a given SBS specification, thereby achieving high TDFL output power. Accordingly, this model shows that a 25 μm core/100 μm inner cladding/400 μm outer cladding, hybrid-pumped TDFA can produce over 1 kW output power while exhibiting an approximately 160° C. temperature gradient along the length of the fiber.

Note that TDFs may be difficult to splice, due in large part to diffusion of the core, and this difficulty may be worsened if the cladding size is increased to reduce polymer temperature. Accordingly, in some examples it may be preferable to keep the fiber cladding as small as possible, so as to support splicing while using standard splice equipment. Still, in some examples, the size of outer cladding 218 may exceed 400 m, in order to drive the thermal gradient high enough to suppress or otherwise reduce SBS, while keeping the polymer temperature below 90° C.

FIG. 6 illustrates calculated effective SBS gain spectra 600 for different temperature profiles of a hybrid-pumped fiber amplifier, in accordance with an example of the present disclosure. The effective SBS gain can be calculated by integrating the gain profile along the fiber length: G(v)=∫₀^{L}P(z)G(v, T(z))dz, where P(z) is the 2 μm signal level at a position z along the fiber and G(v,T(z)) is the SBS gain spectrum. In particular, the integrated SBS gains are shown for several temperature profiles, including a constant temperature profile (solid curve), two linear temperature profiles with gradients of 225° C. and 265° C. (dotted and long-dashed curves, respectively), and the modeled core temperature profile of a hybrid-pumped 2 am fiber laser according to an embodiment (short-dashed curve) from FIG. 5.

The modeled temperature profile from FIG. 5 has a relatively flat section for longitudinal positions between 1 m and 3 m, resulting in a reduction in integrated SBS gain by a factor of 1.97, as shown. However, a more idealized linear 265° C. gradient could reduce the peak gain by a factor of 10.8, as shown. Accordingly, in some embodiments, the hybrid-pumping design parameters (such as core size, inner cladding size, outer cladding size, tandem pump wavelengths, direct diode pump wavelengths, and tandem to direct diode pumping ratio) can be optimized or otherwise selected to produce an approximately linear temperature profile, thereby reducing SBS by a factor greater than 2, and potentially as large as 10.8.

### Method of Pumping a Fiber Laser

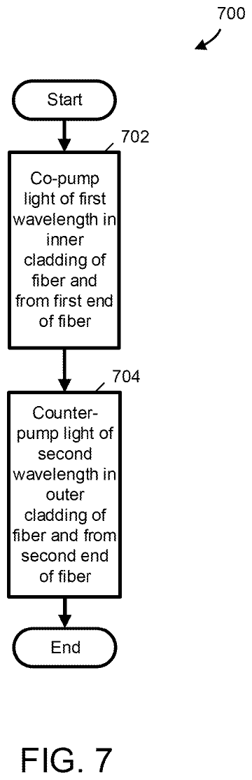

FIG. 7 is a flow diagram illustrating a method 700 of pumping a fiber laser, in accordance with an example of the present disclosure. In various examples, method 700 may be performed with a fiber laser system including a triple-clad fiber. The triple-clad fiber can have a core, an inner cladding around the core, and an outer cladding around the inner cladding. In some examples, the triple-clad fiber is a TDF. In some examples, the laser's output is a narrow linewidth signal with a wavelength between 1.9 microns and 2.1 microns. In some examples, the pumped fiber laser system also includes an amplifier or pre-amplifier stage.

As shown in FIG. 7, pumping the fiber laser starts with co-pumping 702 light of a first wavelength in the inner cladding of the fiber and from a first end of the fiber. In some examples, co-pumping involves tandem pumping, e.g., pumping a TDFA in-band to the 3F4 lasing level by one or more additional TDFLs operating at the first wavelength, which can be between 1900 nanometers and 2000 nanometers. In some examples, the tandem pump includes light of the first wavelength and a X-to-1 pump combiner. The relatively high quantum efficiency of tandem pumping can reduce the heating in the TDF, as it distributes waste heat from the pump diode evenly over the TDFLs.

Next, pumping the fiber laser continues with counter-pumping 704 light of a second wavelength in the outer cladding of the fiber, and from a second end of the fiber. In some examples, the second wavelength is between 790 nanometers and 800 nanometers. In some examples, co-pumping involves direct diode pumping, for example using a direct diode pump including diodes that emit light at the second wavelength and a X-to-1 pump combiner.

Accordingly, method 700 of pumping the disclosed fiber laser provides a method of hybrid-pumping. Because tandem co-pumping has a relatively high quantum efficiency, the temperature of a first end of the TDFL can be relatively low. By contrast, the direct diode counter-pumping produces a large amount of heat, so the temperature of a second end of the TDFL is significantly higher. As a result, method 700 can provide a relatively large longitudinal temperature gradient across the TDFL, as in the example of FIG. 5, which can be tailored by design parameters like core size, inner cladding size, outer cladding size, the tandem pump wavelengths, the direct diode pump wavelengths, and tandem to direct diode pumping ratio. This temperature gradient can significantly suppress or otherwise reduce SBS, enabling the disclosed TDFL to produce high output power over 1 kW at a narrow linewidths.

In some examples, the pumped fiber laser system also includes a first and/or a second cladding light stripper configured to strip out light of the first and second wavelengths, respectively. The first cladding light stripper for stripping the inner cladding can be, for example, between the second pump combiner and an output of the laser system. The second cladding light stripper for stripping the outer cladding can be, for example, between the first pump combiner and the amplifier fiber. The first cladding light stripper can operate independently of the second cladding light stripper.

### Further Example Embodiments

Example 1 is a pumped fiber amplifier system, comprising: a fiber laser; a tandem pump configured to co-pump light of a first wavelength to a first end of the fiber laser; and a direct diode pump configured to counter-pump light of a second wavelength to a second end of the fiber laser; wherein the tandem pump and the direct diode pump in operation, collectively produce a temperature gradient between the first end and the second end.

Example 2 includes the system of Example 1, wherein the temperature gradient between the first end and the second end depends on at least one of: a core fiber size of the fiber laser; an inner cladding size of the fiber laser; an outer cladding size of the fiber laser; the first wavelength; the second wavelength; or a ratio of co-pumping to counter-pumping.

Example 3 includes the system of Example 1 or 2, wherein the first wavelength is between 1900 nanometers and 2000 nanometers, and/or the second wavelength is between 790 nanometers and 800 nanometers.

Example 4 includes the system of any one of Examples 1 through 3, wherein an output wavelength of the fiber laser is between 1.9 microns and 2.1 microns.

Example 5 includes the system of any one of Examples 1 through 4, wherein the tandem pump has a quantum efficiency of at least 80%, and the fiber laser has a power greater than 1 kilowatt.

Example 6 includes the system of any one of Examples 1 through 5, wherein the temperature gradient has a quasi-linear profile along a length between the first and second ends of the fiber laser.

Example 7 includes the system of any one of Examples 1 through 6, wherein the temperature gradient is configured to suppress stimulated Brillouin scattering (SBS), and wherein the fiber laser has a power greater than 1 kilowatt.

Example 8 includes the system of any one of Examples 1 through 7, wherein the fiber laser comprises a doped fiber amplifier laser.

Example 9 includes the system of Example 8, wherein the fiber laser comprises a thulium doped fiber amplifier laser.

Example 10 includes the system of Example 9, wherein: an amplifier fiber of the doped fiber amplifier laser comprises a triple-clad fiber; the tandem pump is configured to co-pump the light of the first wavelength in an inner cladding of the triple-clad fiber; and the direct diode pump is configured to counter-pump the light of the second wavelength in an outer cladding of the triple-clad fiber.

Example 11 is a pumped fiber amplifier system, comprising: a fiber having a core, an inner cladding around the core, and an outer cladding around the inner cladding; a tandem pump configured to co-pump light of a first wavelength in the inner cladding of the fiber and from a first end of the fiber; and a direct diode pump configured to counter-pump light of a second wavelength in the outer cladding of the fiber and from a second end of the fiber.

Example 12 includes the system of Example 11, and includes: a pre-amplifier stage configured to receive a first signal and to output a second signal that is an amplified version of the first signal, the second signal to be received in the core of the fiber.

Example 13 includes the system of Example 11 or 12, wherein: the first wavelength is between 1900 nanometers and 2000 nanometers; and the second wavelength is between 790 nanometers and 800 nanometers.

Example 14 includes the system of any one of Examples 11 through 13, wherein the fiber is a thulium-doped triple-clad amplifier fiber.

Example 15 includes the system of any one of Examples 11 through 14, wherein the tandem pump includes: thulium pumped fiber laser oscillators that emit light of the first wavelength; and a pump combiner.

Example 16 includes the system of any one of Examples 11 through 15, wherein the direct diode pump includes: diodes that emit light at the second wavelength; and a pump combiner.

Example 17 includes the system of any one of Examples 11 through 16, and includes: a first pump combiner to combine signals from the tandem pump; a second pump combiner to combine signals from the direct diode pump; a first cladding light stripper configured to strip out light of the first wavelength, the first cladding light stripper between the second pump combiner and an output of the pumped fiber amplifier system; and a second cladding light stripper configured to strip out light of the second wavelength, the second cladding light stripper between the first pump combiner and the second pump combiner; wherein the first cladding light stripper operates independently of the second cladding light stripper.

Example 18 includes the system of any one of Examples 11 through 17, wherein: the pumped fiber amplifier system is configured to amplify an input signal with between 50 decibel and 60 decibel of gain; and the input signal is configured to be amplified to at least 1 kilowatt of output power.

Example 19 is a method of pumping a fiber amplifier, the method comprising: co-pumping light of a first wavelength to a first end of the fiber amplifier using a tandem pumping technique; and counter-pumping light of a second wavelength to a second end of the fiber amplifier; wherein a temperature gradient forms between the first end and the second end in response to the co-pumping and the counter-pumping.

Example 20 includes the method of Example 19, wherein the first wavelength is between 1900 nanometers and 2000 nanometers, and/or the second wavelength is between 790 nanometers and 800 nanometers.

Example 21 includes the method of Example 19 or 20, wherein an output wavelength of the fiber amplifier is between 1.9 microns and 2.1 microns.

Example 22 includes the method of any one of Examples 19 through 21, wherein a quantum efficiency of the tandem pumping technique is at least 80%.

Example 23 includes the method of any one of Examples 19 through 22, wherein counter-pumping uses a direct diode pumping technique.

Example 24 includes the method of any one of Examples 19 through 23, wherein the temperature gradient suppresses stimulated Brillouin scattering (SBS), and wherein the fiber amplifier has a power greater than 1 kilowatt.

Example 25 includes the method of any one of Examples 19 through 24, wherein the temperature gradient has a quasi-linear profile along a length between the first and second ends of the fiber amplifier.

Example 26 includes the method of any one of Examples 19 through 25, wherein the fiber amplifier comprises a thulium doped fiber amplifier laser.

Example 27 includes the method of any one of Examples 19 through 26, wherein the fiber amplifier comprises a doped fiber amplifier laser, and wherein: an amplifier fiber of the doped fiber amplifier laser comprises a triple-clad fiber; the light of the first wavelength is co-pumped in an inner cladding of the triple-clad fiber; and the light of the second wavelength is counter-pumped in an outer cladding of the triple-clad fiber.

The foregoing description of the embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

1. A pumped fiber amplifier system, comprising:
a fiber laser;
a tandem pump configured to co-pump light of a first wavelength to a first end of the fiber laser; and
a direct diode pump configured to counter-pump light of a second wavelength to a second end of the fiber laser;
wherein the tandem pump and the direct diode pump in operation, collectively produce a temperature gradient between the first end and the second end.

2. The system of claim 1, wherein the temperature gradient between the first end and the second end depends on at least one of:
a core fiber size of the fiber laser;
an inner cladding size of the fiber laser;
an outer cladding size of the fiber laser;
the first wavelength;
the second wavelength; or
a ratio of co-pumping to counter-pumping.

3. The system of claim 1, wherein the first wavelength is between 1900 nanometers and 2000 nanometers, and/or the second wavelength is between 790 nanometers and 800 nanometers.

4. The system of claim 1, wherein an output wavelength of the fiber laser is between 1.9 microns and 2.1 microns.

5. The system of claim 1, wherein the tandem pump has a quantum efficiency of at least 80%, and the fiber laser has a power greater than 1 kilowatt.

6. The system of claim 1, wherein the temperature gradient has a quasi-linear profile along a length between the first and second ends of the fiber laser.

7. The system of claim 1, wherein the temperature gradient is configured to suppress stimulated Brillouin scattering (SBS), and wherein the fiber laser has a power greater than 1 kilowatt.

8. The system of claim 1, wherein the fiber laser comprises a doped fiber amplifier laser.

9. The system of claim 8, wherein the fiber laser comprises a thulium doped fiber amplifier laser.

10. The system of claim 9, wherein:
an amplifier fiber of the doped fiber amplifier laser comprises a triple-clad fiber;
the tandem pump is configured to co-pump the light of the first wavelength in an inner cladding of the triple-clad fiber; and
the direct diode pump is configured to counter-pump the light of the second wavelength in an outer cladding of the triple-clad fiber.

11. A pumped fiber amplifier system, comprising:
a fiber having a core, an inner cladding around the core, and an outer cladding around the inner cladding;
a tandem pump configured to co-pump light of a first wavelength in the inner cladding of the fiber and from a first end of the fiber; and
a direct diode pump configured to counter-pump light of a second wavelength in the outer cladding of the fiber and from a second end of the fiber.

12. The system of claim 11, comprising a pre-amplifier stage configured to receive a first signal and to output a second signal that is an amplified version of the first signal, the second signal to be received in the core of the fiber.

13. The system of claim 11, wherein:
the first wavelength is between 1900 nanometers and 2000 nanometers; and
the second wavelength is between 790 nanometers and 800 nanometers.

14. The system of claim 11, wherein the fiber is a thulium-doped triple-clad amplifier fiber.

15. The system of claim 11, wherein the tandem pump includes:
thulium pumped fiber laser oscillators that emit light of the first wavelength; and
a pump combiner.

16. The system of claim 11, wherein the direct diode pump includes:
diodes that emit light at the second wavelength; and
a pump combiner.

17. The system of claim 11, comprising:
a first pump combiner to combine signals from the tandem pump;
a second pump combiner to combine signals from the direct diode pump;
a first cladding light stripper configured to strip out light of the first wavelength, the first cladding light stripper between the second pump combiner and an output of the pumped fiber amplifier system; and
a second cladding light stripper configured to strip out light of the second wavelength, the second cladding light stripper between the first pump combiner and the second pump combiner;
wherein the first cladding light stripper operates independently of the second cladding light stripper.

18. (canceled)

19. A method of pumping a fiber amplifier, the method comprising:
co-pumping light of a first wavelength to a first end of the fiber amplifier using a tandem pumping technique; and
counter-pumping light of a second wavelength to a second end of the fiber amplifier;
wherein a temperature gradient forms between the first end and the second end in response to the co-pumping and the counter-pumping.

20. The method of claim 19, wherein the fiber amplifier comprises a doped fiber amplifier laser, and wherein:
an amplifier fiber of the doped fiber amplifier laser comprises a triple-clad fiber;
the light of the first wavelength is co-pumped in an inner cladding of the triple-clad fiber; and
the light of the second wavelength is counter-pumped in an outer cladding of the triple-clad fiber.
